(19) United States
(12) Patent Application Publication
(10) Pub. No.: US 2018/0364066 A1
(43) Pub. Date: Dec. 20, 2018

(54) LINEAR POSITION MAGNETIC FIELD SENSOR WITH DIFFERENTIAL SENSING AND A DIFFERENTIAL MAGNETIC FIELD SENSING METHOD

(71) Applicant: Infineon Technologies AG, Neubiberg (DE)

(72) Inventors: Armin SATZ, Villach (AT); Helmut KOECK, Villach (AT); Dirk HAMMERSCHMIDT, Finkenstein (AT); Gernot BINDER, Klagenfurt (AT)

(73) Assignee: Infineon Technologies AG, Neubiberg (DE)

(21) Appl. No.: 15/623,659

(22) Filed: Jun. 15, 2017

(51) Int. Cl. G01D 5/12

(52) U.S. Cl. CPC G01D 5/12

(57) ABSTRACT

Magnetic field position sensors and sensing methods are provided. A magnetic field position sensor includes at least two magnetic field sensor elements configured to generate sensor signals in response to a magnetic field, where the at least two magnetic field sensor elements are sensitive to a same magnetic field component of the magnetic field, and a sensor circuit configured to generate a differential measurement signal, substantially independent from homogeneous external magnetic stray fields, based on the sensor signals.

### FIELD

The present disclosure relates generally to magnetic position sensing, and, more particularly, to stray-field robust magnetic position sensors.

### BACKGROUND

Magnetic sensors include magnetoresistive sensors and Hall-effect sensors (Hall sensors), for example. Magnetoresistance is a property of a material to change the value of its electrical resistance when an external magnetic field is applied to it. Some examples of magnetoresistive effects are Giant Magneto-Resistance (GMR), which is a quantum mechanical magnetoresistance effect observed in thin-film structures composed of alternating ferromagnetic and non-magnetic conductive layers, Tunnel Magneto-Resistance (TMR), which is a magnetoresistive effect that occurs in a magnetic tunnel junction (MTJ), which is a component consisting of two ferromagnets separated by a thin insulator, or Anisotropic Magneto-Resistance (AMR), which is a property of a material in which a dependence of electrical resistance on the angle between the direction of electric current and direction of magnetization is observed. The plurality of different magnetoresistive effects is commonly abbreviated as xMR, wherein the “x” acts as a placeholder for the various magnetoresistive effects. xMR sensors can detect the orientation of an applied magnetic field by measuring sine and cosine angle components with monolithically integrated magnetoresistive sensor elements.

A Hall effect sensor is a transducer that varies its output voltage (Hall voltage) in response to a magnetic field. It is based on the Hall effect which makes use of the Lorentz force. The Lorentz force deflects moving charges in the presence of a magnetic field which is perpendicular to the current flow through the sensor or Hall plate. Thereby a Hall plate can be a thin piece of semiconductor or metal. The deflection causes a charge separation which causes a Hall electrical field. This electrical field acts on the charge in the opposite direction with regard to the Lorentz Force. Both forces balance each other and create a potential difference perpendicular to the direction of current flow. The potential difference can be measured as a Hall voltage and varies in a linear relationship with the magnetic field for small values. Hall effect sensors can be used for proximity switching, positioning, speed detection, and current sensing applications.

Currently, in proximity switching, movement sensing and positioning sensing applications, a Hall monocell configuration may be used. For example, a magnetized back bias magnet in combination with a Hall monocell sensor generates a signal as a ferrous target (i.e., the sensed object) moves in front of the sensor.

On the downside, Hall monocell sensors have a disadvantage in terms of stray-field robustness. Stray-fields are magnetic fields that are introduced by magnetic harsh environments or other external means located in the proximal environment of the sensor. A magnetic harsh environment can be caused by large current densities located in the vicinity of the sensor (Hybridization of vehicles) or electric motors next to the sensing location. For example, components located within a vehicle (e.g., for hybrid cars due to current rails driving high electrical currents close to the sensing device or due to inductive battery charging) may produce a magnetic harsh environment. In addition, currents flowing through a railway of a train system that generate a magnetic field may cause stray-field disturbance that is detectable when a vehicle is proximate to the railway. A stray-field disturbance may contribute to the measured sensing signal. This may cause inaccuracies in the signals generated by the sensor and may affect the overall performance of the sensor system.

Therefore, an improved device that has a higher tolerance for stray-fields may be desirable.

### SUMMARY

Magnetic field position sensors and sensing methods are provided.

In an example embodiment, a magnetic field position sensor includes at least two magnetic field sensor elements configured to generate sensor signals in response to a magnetic field, where the at least two magnetic field sensor elements are sensitive to a same magnetic field component of the magnetic field, and a sensor circuit configured to generate a differential measurement signal, substantially independent from homogeneous external magnetic stray fields, based on the sensor signals.

In another example embodiment, a magnetic field sensing method includes measuring a magnetic field using at least two magnetic field sensor elements configured to generate sensor signals in response to the magnetic field, where the at least two magnetic field sensor elements are sensitive to a same magnetic field component of the magnetic field, and generating a differential measurement signal, substantially independent from homogeneous external magnetic stray fields, based on the sensor signals.

### BRIEF DESCRIPTION OF THE DRAWINGS

Embodiments are described herein making reference to the appended drawings.

FIGS. 1A-C illustrate schematic diagrams of a magnetic field sensing principle of one or more ferromagnetic targets according to one or more embodiments;

FIG. 1D illustrates a graph diagram of an output signal according to one or more embodiments;

FIG. 2 shows a schematic diagram of a sensor system according to one or more embodiments;

FIG. 3 shows a schematic diagram of a sensor circuit implemented according to one or more embodiments;

FIG. 4 shows a schematic diagram of a sensor system according to one or more embodiments;

FIG. 5 shows a schematic diagram of another sensor system according to one or more embodiments;

FIG. 6 shows a schematic diagram of a another sensor system according to one or more embodiments; and

FIG. 7 shows a flow diagram of a magnetic field sensing method according to one or more embodiment.

### DETAILED DESCRIPTION

In the following, details are set forth to provide a more thorough explanation of the exemplary embodiments. However, it will be apparent to those skilled in the art that embodiments may be practiced without these specific details. In other instances, well-known structures and devices are shown in block diagram form or in a schematic view rather than in detail in order to avoid obscuring the embodiments. In addition, features of the different embodiments described hereinafter may be combined with each other, unless specifically noted otherwise.

Further, equivalent or like elements or elements with equivalent or like functionality are denoted in the following description with equivalent or like reference numerals. As the same or functionally equivalent elements are given the same reference numbers in the figures, a repeated description for elements provided with the same reference numbers may be omitted. Hence, descriptions provided for elements having the same or like reference numbers are mutually exchangeable.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In embodiments described herein or shown in the drawings, any direct electrical connection or coupling, i.e., any connection or coupling without additional intervening elements, may also be implemented by an indirect connection or coupling, i.e., a connection or coupling with one or more additional intervening elements, or vice versa, as long as the general purpose of the connection or coupling, for example, to transmit a certain kind of signal or to transmit a certain kind of information, is essentially maintained. Features from different embodiments may be combined to form further embodiments. For example, variations or modifications described with respect to one of the embodiments may also be applicable to other embodiments unless noted to the contrary.

Embodiments relate to sensors and sensor systems, and to obtaining information about sensors and sensor systems. A sensor may refer to a component which converts a physical quantity to be measured to an electric signal, for example, a current signal or a voltage signal. The physical quantity may for example comprise a magnetic field, an electric field, a pressure, a force, a current or a voltage, but is not limited thereto.

A magnetic field sensor, for example, includes one or more magnetic field sensor elements that measure one or more characteristics of a magnetic field (e.g., an amount of magnetic field flux density, a field strength, a field angle, a field direction, a field orientation, etc.) corresponding to detecting and/or measuring the magnetic field pattern of an element that generates the magnetic field (e.g., a magnet, a current-carrying conductor (e.g., a wire), the Earth, or other magnetic field source). Each magnetic field sensor element is configured to generate a sensor signal in response to one or more magnetic fields.

For example, a sensor signal (e.g., a voltage signal) generated by each magnetic field sensor element may be proportional to the magnitude of the magnetic field. Further, it will be appreciated that the terms “sensor” and “sensing element” may be used interchangeably throughout this description, and the terms “sensor signal” and “measurement value” may be used interchangeably throughout this description.

Magnetic field sensor elements include, but are not limited to Hall-effect sensors (Hall sensors), or magneto-resistive xMR sensors, such as AMR, GMR, or TMR sensor elements.

In some examples, Hall sensor elements may be implemented as a vertical Hall sensor elements. A vertical Hall sensor is a magnetic field sensor which is sensitive to a magnetic field component which extends parallel to their surface. This means they are sensitive to magnetic fields parallel, or in-plane, to the IC surface. The plane of sensitivity may be referred to herein as a “sensitivity-axis” or “sensing axis” and each sensing axis has a reference direction. For Hall sensor elements, voltage values output by the sensor elements change according to the magnetic field strength in the direction of the sensing axis.

In other examples, Hall sensor elements may be implemented as lateral Hall sensor elements. A lateral Hall sensor is sensitive to a magnetic field component perpendicular to their surface. This means they are sensitive to magnetic fields vertical, or out-of-plane, to the integrated circuit (IC) surface. The plane of sensitivity may be referred to herein as a “sensitivity-axis” or “sensing axis” and each sensing axis has a reference direction. For Hall sensor elements, voltage values output by the sensor elements change according to the magnetic field strength in the direction of the sensing axis.

In other examples, xMR sensor elements may be utilized. Each xMR sensor element may be, for example, a single-axis or a multi-axis xMR sensor element that has a sensing axis utilized for measuring a magnetic field. This sensing axis may, for example, be aligned with one of the in-plane magnetic field components for measuring that field component. Each xMR sensor element may include a reference layer having a reference direction which provides a sensing direction corresponding to the sensing axis. Accordingly, if a magnetic field component points exactly in the same direction as the reference direction, a resistance of the xMR sensor element is at a maximum, and, if a magnetic field component points exactly in the opposite direction as the reference direction, the resistance of the xMR sensor element is at a minimum.

According to one or more embodiments, a magnetic field sensor and a sensor circuit may be both accommodated (i.e., integrated) in the same chip package (e.g., a plastic encapsulated package, such as leaded package or leadless package, or a surface mounted device (SMD)-package). This chip package may also be referred to as sensor package. The sensor package may be combined with a back bias magnet to form a sensor module, sensor device, or the like.

The sensor circuit may be referred to as a signal processing circuit and/or a signal conditioning circuit that receives one or more signals (i.e., sensor signals) from one or more magnetic field sensor elements in the form of raw measurement data and derives, from the sensor signal, a measurement signal that represents the magnetic field. Signal conditioning, as used herein, refers to manipulating an analog signal in such a way that the signal meets the requirements of a next stage for further processing. Signal conditioning may include converting from analog to digital (e.g., via an analog-to-digital converter), amplification, filtering, converting, biasing, range matching, isolation and any other processes required to make a sensor output suitable for processing after conditioning.

Thus, the sensor circuit may include a digital converter (ADC) that converts the analog signal from the one or more sensor elements to a digital signal. The sensor circuit may also include a digital signal processor (DSP) that performs some processing on the digital signal, to be discussed below. Therefore, the sensor package comprises a circuit which conditions and amplifies the small signal of the magnetic field sensor element via signal processing and/or conditioning.

A sensor device, as used herein, may refer to a device which includes a sensor and sensor circuit as described above. A sensor device may be integrated on a single semiconductor die (e.g., silicon die or chip), although, in other embodiments, a plurality of dies may be used for implementing a sensor device. Thus, the sensor and the sensor circuit are disposed on either the same semiconductor die or on multiple dies in the same package. For example, the sensor might be on one die and the sensor circuit on another die such that they are electrically connected to each other within the package. In this case, the dies may be comprised of the same or different semiconductor materials, such as GaAs and Si, or the sensor might be sputtered to a ceramic or glass platelet, which is not a semiconductor.

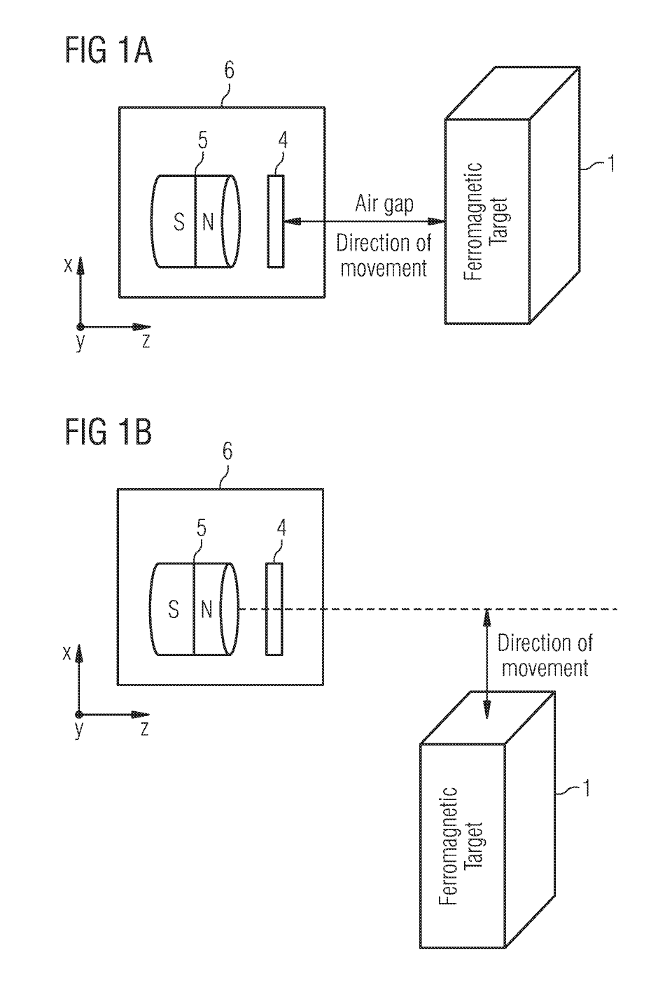

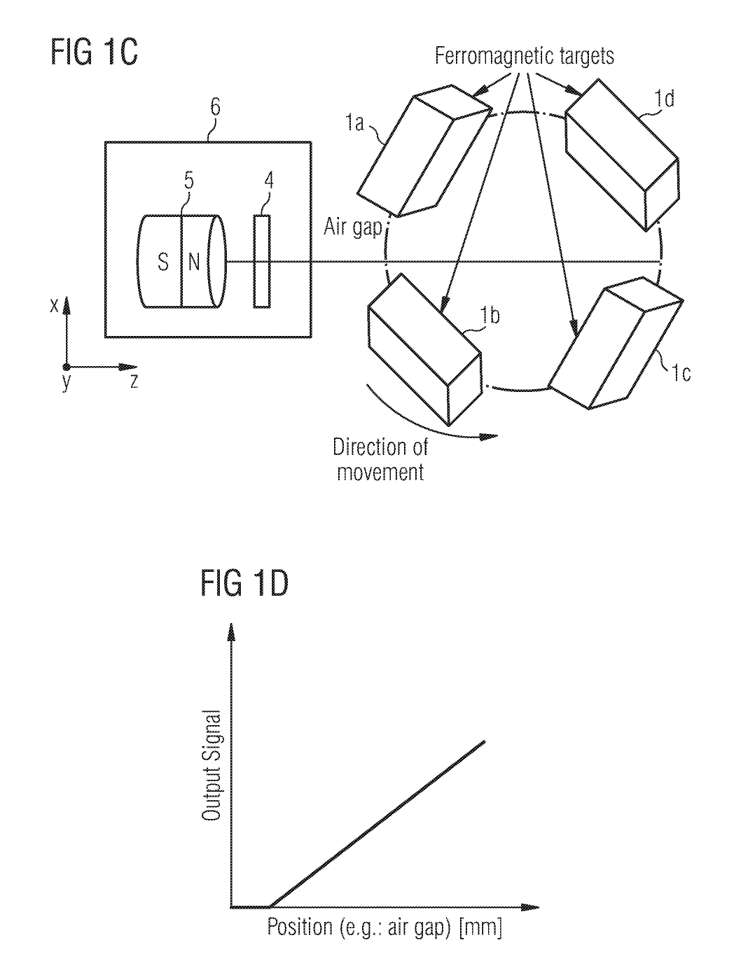

FIGS. 1A-D illustrate a magnetic field sensing principle of one or more ferromagnetic targets 1 according to one or more embodiments. In particular, the one or more ferromagnetic targets 1 is made of a ferromagnetic material (e.g., iron) that attracts magnetic fields. In addition, a sensor arrangement 4 is configured to sense a magnetic field produced by a back bias magnet 5, where the sensor arrangement 4 and the back bias magnet 5 comprise a sensor module 6. The sensor arrangement 4 may generally be referred to herein as a sensor or sensor integrated circuit (IC), and may include two or more magnetic field sensor elements and a sensor circuit. Furthermore, sensor arrangement 4 may be disposed in a sensor package.

Sensors 4 shown in FIGS. 1A-C are configured to convert magnetic or magnetically encoded information into electrical signals for processing by sensor circuits and may be used in many different types of application such as sensing position, proximity, speed, velocity or directional movement. In particular, magnetic field lines of the bias magnetic field produced by the back bias magnet 5 are pulled more strongly in the direction towards the ferromagnetic target 1 as the position of the ferromagnetic target 1 becomes closer to the back bias magnet 5. Conversely, the magnetic field lines of the bias magnetic field become more relaxed (i.e., less pulled) as the position of the ferromagnetic target 1 becomes further from the back bias magnet 5, or in the absence of the back bias magnet 5.

Thus, directional field components of the bias magnetic field change depending on the position and/or movement of the ferromagnetic target 1. Since the sensor 4 is placed adjacent or in proximity to to the back bias magnet 5, the sensor 4 is capable of detecting a change, in orientation and/or strength, in one or more directional field components of the bias magnetic field.

The directional field components may include a magnetic field component Bx (i.e., the magnetic field in the x-plane), a magnetic field component By (i.e., the magnetic field in the y-plane), or a magnetic field component Bz (i.e., the magnetic field in the z-plane). The magnetic field components Bx and By may be referred to as in-plane field components, since they are in-plane to the main surface of the sensor arrangement 4 (i.e., the sensor IC). Conversely, the magnetic field component Bz may be referred to as an out-of-plane field component, since it is out-of-plane to the main surface of the sensor arrangement 4 (i.e., the sensor IC).

It will be further appreciated that in some embodiments the target 1 itself may be magnetized. In this case, a back bias magnet may or may not be used since the sensor 4 can be configured to detect the magnetic field produced by the target 1. In other cases, a ferromagnetic material may be used to replace the back bias magnet to aid in sensing a magnetic field of a magnetized target.

FIG. 1A shows an example of a linear movement between the sensor module 6 (i.e., the sensor arrangement 4 in combination with the back bias magnet 5) and the ferromagnetic target 1. In particular, the ferromagnetic target 1 moves in a back-and-forth or oscillating path between two extreme positions in the z-direction. As the ferromagnetic target 1 moves along its path in the z-direction, an air gap between the sensor module 6 and the ferromagnetic target 1 changes (i.e., the air gap becomes smaller or larger) and changes at least one directional field component of the bias magnetic field based on its position.

For example, as the ferromagnetic target 1 moves closer to the sensor module 6 and the air gap decreases, the magnetic field lines of the magnetic field produced by the back bias magnet 5 are pulled in the z-direction towards the ferromagnetic target 1. Thus, the magnetic field lines are pulled away from the x and y-axes (i.e., the x and y-sensor planes) and the magnetic field strength in the x and y-directions is reduced. Meanwhile, the magnetic field strength in the z-direction is increased. The opposite phenomenon occurs as the ferromagnetic target 1 moves further from the sensor module 6. Thus, a mechanical movement parameter output-protocol of the sensor arrangement 4 may be coded in a linear way such that the output (i.e., a measurement signal) of the sensor circuit of the sensor arrangement 4 is linear with respect to the position and movement of the ferromagnetic target 1.

FIG. 1B shows another example of a linear movement of a ferromagnetic target 1. In particular, the ferromagnetic target 1 moves in a back-and-forth or oscillating path between two extreme positions in the x-direction, parallel to the main surface of the sensor arrangement 4. Again, the orientation and/or strength of one or more of the directional field components changes according to the position of the ferromagnetic target 1 relative to the sensor arrangement 4. Thus, a mechanical movement parameter output-protocol of the sensor arrangement 4 may be coded in a linear way such that the output (i.e., a measurement signal) of the sensor circuit of the sensor arrangement 4 is linear with respect to the position and movement of the ferromagnetic target 1.

FIG. 1C shows another example of a rotational movement of multiple ferromagnetic targets 1a-d (generally referred to as ferromagnetic target 1). The ferromagnetic targets 1a-d may be separate objects or may be part of a single, integral member, such as teeth on a toothed wheel or shaft. As the ferromagnetic targets 1a-d rotate, they alternate past the sensor module 6, causing one or more directional field components to oscillate between two extrema. For example, the magnetic field sensor elements within the sensor arrangement 4 may sense a change in the x-axis and/or y-axis magnetic field strength and/or orientation that varies as a sinusoidal waveform (i.e., as a signal modulation), the frequency of which corresponds to a speed of rotation of the ferromagnetic targets 1a-d, which may further corresponds to a speed of rotation of a drive shaft (e.g., camshaft) that drives the rotation of the wheel (in the case where the ferromagnetic targets 1a-d are teeth of a toothed wheel). Thus, the sensor circuit of the sensor arrangement 4 may be configured to receive signals (i.e., sensor signals) from the magnetic field sensor elements and derive, from the sensor signals, a measurement signal that represents the magnetic field as a signal modulation.

In each example provided herein, the sensor circuit may further convert that measurement signal into an output signal that is a function of the position of the ferromagnetic target 1. Thus, the output signal may represent the linear position of each ferromagnetic target 1 with respect to the sensor module 6. The output signal may also be output to an external controller, control unit or processor (e.g., an electronic control unit (ECU)).

FIG. 1D shows an example of an output signal as a linear function of a position of the ferromagnetic target 1 relative to the sensor arrangement 4.

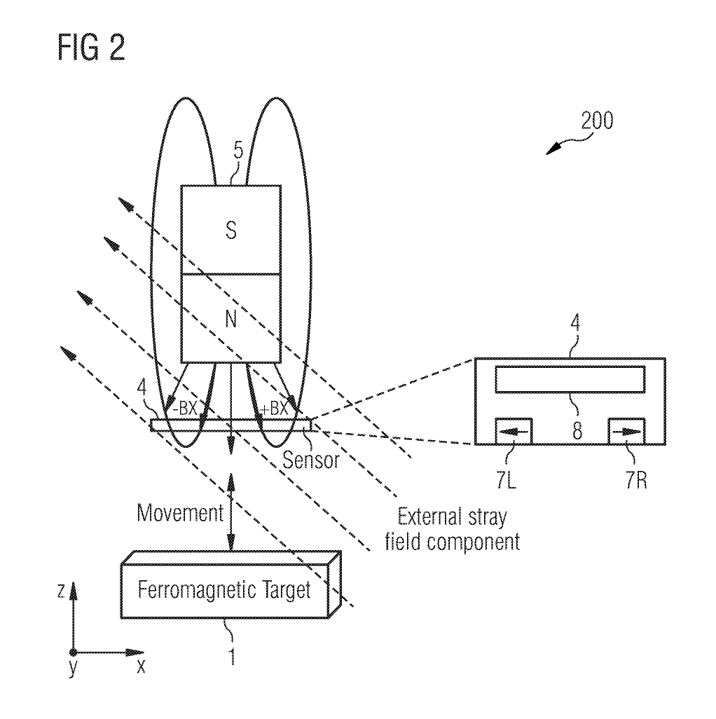

FIG. 2 shows a schematic diagram of a sensor system 200 according to one or more embodiments. In particular, FIG. 2 shows a sensor system 200 including a sensor arrangement 4 and a back bias magnet 5 in the presence of a homogenous external stray magnetic field configured to track the (linear) movement of ferromagnetic target 1. It is to be noted that an enlarged cross sectional view of the sensor arrangement 4 is drawn to the right, connected by dashed expansion lines to the sensor element 4 drawn inside the magnetic field lines between the back bias magnet 5 and the target 1.

The sensor arrangement 4 includes two magnetic field sensor elements 7L and 7R, spaced apart, having a same sensitivity axis (e.g., x-axis) but aligned in opposing sensing directions. Specifically, the magnetic field sensor element 7L has a sensing direction in the −Bx direction, while the magnetic field sensor element 7R has a sensing direction in the +Bx direction. Thus, both magnetic field sensor elements 7L and 7R are sensitive to magnetic fields in the x-plane, but generate signals with opposing signs relative to the in-plane magnetic field component Bx.

The sensor arrangement 4 further includes a sensor circuit 8 configured to receive the sensor signals from the magnetic field sensor elements 7L and 7R, and generate an analog signal, referred to as a differential measurement signal, therefrom using a differential calculation. The differential measurement signal, for example, may represent a difference (i.e., a delta Bx value) between the sensor values (sensor signals) generated by the magnetic field sensor elements 7L and 7R due to the magnetic field component Bx impinging on each sensor element location.

The differential equation for the example illustrated in FIG. 2 may a first order differential equation, such as:

SE_{Δ}=SE_{R}−SE_{L} (1),

where SE_{R} corresponds to a resistance value (e.g., for an xMR sensor element) or a voltage value (e.g., for a Hall effect sensor element) generated by magnetic field sensor element 7R, SE_{L} corresponds to a resistance value or a voltage value generated by magnetic field sensor element 7L, and SE_{Δ} corresponds to a delta measurement value and represents a value of the differential measurement signal.

It will be appreciated that while the magnetic field sensor elements 7L and 7R in FIG. 2 are configured to sense an in-plane magnetic field component Bx in opposing sensing directions, the embodiments are not limited thereto. A differential measurement signal may be generated as long as the magnetic field sensor elements 7L and 7R are configured to detect magnetic field components in the same plane (e.g., x or y in-plane field components or z out-of-plane field components). Further, the magnetic field sensor elements 7L and 7R may be configured to have opposing sensing directions, as in FIG. 2, or a same sensing direction. Accordingly, the differential equation can be adjusted to accommodate parallel or anti-parallel sensing directions, so long as a delta value is generated therefrom.

The sensor circuit 8 may further convert the differential measurement signal into an output signal based on a function of the position of the ferromagnetic target 1 (e.g., based on the linear position of ferromagnetic target 1 relative to the sensor as best seen in FIG. 1D). For example, the sensor circuit 8 may include a switching mechanism that switches a logic state (e.g., from low to high, or from high to low) of the output signal according to the delta Bx value of the differential measurement signal meeting a trigger condition.

Alternatively, switching mechanism may be a pulse mechanism such that a signal pulse is generated at a trigger event that causes the output signal of the sensor arrangement 4 to be modulated, as opposed to a single logic state transition. In this case, the sensor circuit 8 may deliver a pulse of known length if a trigger event is detected. In some systems, the pulse length may be varied via pulse width modulation, for example, in order to deliver additional information such as an indication of sufficient magnetic field strength, movement direction or error flags.

Further still, the sensor circuit 8 may output the differential measurement signal as the output signal, or may convert the differential measurement signal to another type of modulated signal (e.g., a linear signal) based on a function of a delta Bx value and the position of the ferromagnetic target.

A trigger event may refer to crossing a threshold value. For example, the delta Bx value generated by the sensor circuit 8 may decreases as the ferromagnetic target 1 becomes closer to the sensor elements 7L and 7R (e.g., the air gap decreases), and the delta Bx value may increase as the ferromagnetic target 1 becomes farther from the sensor elements 7L and 7R (e.g., the air gap increases).

Thus, a threshold value or a switching point may be set such that the output signal is modulated based on the delta Bx value. The threshold value may be configured to correspond to a specific distance or a specific position of the ferromagnetic target 1 with respect to the sensor arrangement 4 (e.g., from a middle point between sensor elements). Furthermore, the switching point may be directional dependent such that trigger event occurs only while the ferromagnetic target 1 moves in a particular direction (e.g., as it moves closer to or farther from the sensor arrangement 4).

The sensor circuit 8 may also be configured to monitor multiple trigger events, such as threshold crossings of two or more threshold values (e.g., a minimum threshold value or a maximum threshold value), and generate the output signal based on each trigger event or selected trigger events.

In view of the above, it can be appreciated that, due to the geometry of the back bias magnet 5, a differential magnetic field is produced at the two positions of sensor elements 7L and 7R due to the in-plane component Bx of the magnetic field impinging at those two positions. A differential measurement signal may be produced by the sensor circuit 8 using differential calculus on the two sensor signals, and an output signal may be generated based on a position or a function of the position of the ferromagnetic target 1. An external device may use the output signal to calculate a position of the ferromagnetic target 1 with respect to the sensor module 6, to determine whether the ferromagnetic target 1 is within or outside a desired proximal range from the sensor module 6, and/or to determine a speed of the ferromagnetic target 1 by, for example, counting a number of pulses of the modulated output signal.

Now consider that an external stray magnetic field is present. When an external stray magnetic field is present, the external stray magnetic field will add a cumulative effect to the already produced back bias field, creating a total magnetic field (target magnetic field+stray magnetic field) that is detectable by the magnetic field sensor elements 7L and 7R. That is, each magnetic field sensor element 7L and 7R may sense the Bx component of the external stray magnetic field in addition to the Bx component of the back bias magnetic field. However, it is noted that the external stray magnetic field affects each magnetic field sensor element 7L and 7R in a similar manner.

In particular, the stray magnetic field may cause a shift in the sensed total magnetic field of each magnetic field sensor element 7L and 7R by the same or similar amount (i.e., within an acceptable tolerance). Thus, the sensor value generated by each magnetic field sensor element 7L and 7R will change by the same or similar positive or negative amount depending on the orientation and/or strength of the Bx component of the stray magnetic field. As a result, the difference (i.e., delta Bx) between the sensor values remains the substantially the same as compared to the difference that would be realized in the absence of the stray magnetic field. Since the delta Bx remains substantially the same, the stray field in the x-direction can be canceled out using the differential calculus described above.

Accordingly, the sensor circuit 8 is configured to receive the sensor signals from the magnetic field sensor elements 7L and 7R, and generate a differential measurement signal therefrom using a differential calculation that cancels out the homogeneous stray-fields in the x-direction. The calculation focuses on the x-component of the stray-fields since the sensing axis used for the position sensing of the ferromagnetic target 1 is the x-axis, while the y and z-components do not impact the position sensing in this example.

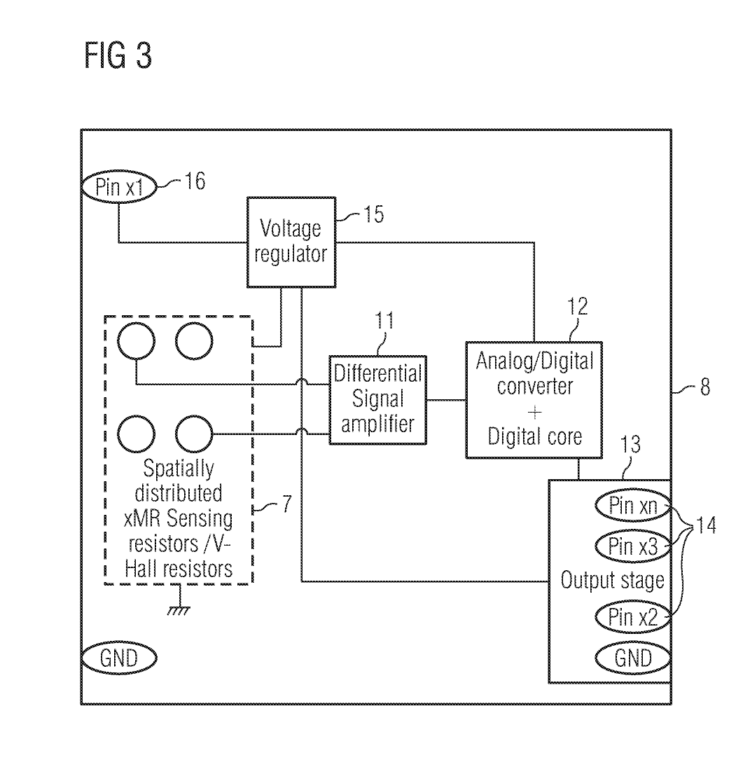

FIG. 3 illustrates a schematic diagram of a sensor circuit 8 implemented according to one or more embodiments. The sensor circuit includes spatially distributed magnetic field sensor elements 7 configured to generate a sensor signal in response to a magnetic field impinging thereon. At least two of the magnetic field sensor elements 7 are connected to a differential signal amplifier 11 configured to generate a differential measurement signal from the sensor signals received from the magnetic field sensor elements 7. For example, two of the magnetic field sensor elements 7 may correspond to sensor elements 7L and 7R shown in FIG. 2.

The sensor circuit 8 further includes an ADC and digital core logic 12 configured to preform signal conditioning on the differential measurement signal. In particular, the ADC and digital core logic 12 may be configured to convert the differential measurement signal into a digital output signal based on one or more signal generation techniques. For example, the ADC and digital core logic 12 may include one or more processors and/or digital logic to generate the output signal based on a trigger event or based on a linear function of the differential measurement signal and the position of the ferromagnetic target 1.

The sensor circuit 8 further includes an output stage 13 configured to receive the output signal from the ADC and digital core logic 12, and provide the output signal to one or more output pins 14 of the sensor circuit 8 (i.e., output pins of the sensor chip). Thus, the output signal may be provided to an external device for further use.

The sensor circuit 8 further includes a voltage regulator 15 configured to regulate and stabilize a voltage provided to one or more circuit components (e.g., magnetic field sensor elements 7, differential signal amplifier 11, ADC and digital core logic 12 and output stage 13). The voltage regulator 15 may receive power from a voltage source, such as a battery, via input pin 16, and may have one or more connections to ground GND.

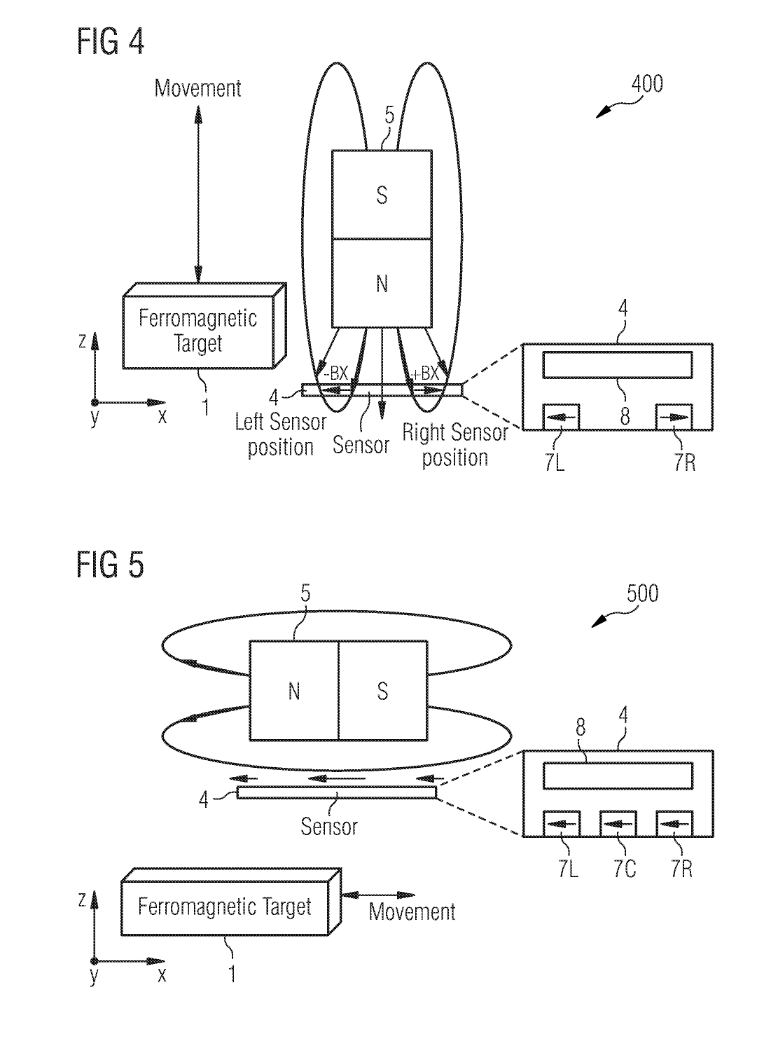

FIG. 4 shows a schematic diagram of a sensor system 400 according to one or more embodiments. It is to be noted that an enlarged cross sectional view of the sensor arrangement 4 is drawn to the right, connected by dashed expansion lines to the sensor element 4 drawn inside the magnetic field lines.

In particular, similar to the sensor system 200 shown in FIG. 2, sensor system 400 includes sensor arrangement 4, a back bias magnet 5 and two magnetic field sensor elements 7L and 7R, spaced apart, having a same sensitivity axis (e.g., x-axis) but aligned in opposing sensing directions. However, instead of the ferromagnetic target 1 moving linearly in front of the sensor module (i.e., sensor arrangement 4 and back bias magnet 5), the ferromagnetic target 1 moves linearly along a path that traverses a side of the sensor module. However, despite the shift in the placement of the ferromagnetic target 1 relative to the sensor module, equation (1) may be used to calculate the differential measurement signal based on the sensor signals generated by magnetic field sensor elements 7L and 7R.

FIG. 5 shows a schematic diagram of a sensor system 500 according to one or more embodiments. It is to be noted that an enlarged cross sectional view of the sensor arrangement 4 is drawn to the right, connected by dashed expansion lines to the sensor element 4 drawn adjacent to the magnetic field lines.

In particular, similar to the sensor system 200 shown in FIG. 2, sensor system 500 includes sensor arrangement 4 and a back bias magnet 5. However, the sensor arrangement 4 is arranged along a side of the back bias magnet 5 and may span laterally across both magnetic poles of the back bias magnet 5.

Additionally, the sensor system includes three magnetic field sensor elements 7L, 7C and 7R, spaced apart, having a same sensitivity axis (e.g., x-axis) aligned a same sensing direction (e.g., the −Bx direction). Thus, a second order differential equation may be used to generate the differential measurement signal from the sensor signals generated by magnetic field sensor elements 7L, 7C and 7R. For example, the sensor circuit 8 may use equation (2) to generate the differential measurement signal:

SE_{Δ}=(SE_{C}−SE_{L})−(SE_{C}−SE_{R}) (2),

where SE_{R} corresponds to a resistance value (e.g., for an xMR sensor element) or a voltage value (e.g., for a Hall effect sensor element) generated by magnetic field sensor element 7R, SE_{L} corresponds to a resistance value or a voltage value generated by magnetic field sensor element 7L, SE_{C} corresponds to a resistance value or a voltage value generated by magnetic field sensor element 7C, and SE_{Δ} corresponds to a delta measurement value and represents a value of the differential measurement signal.

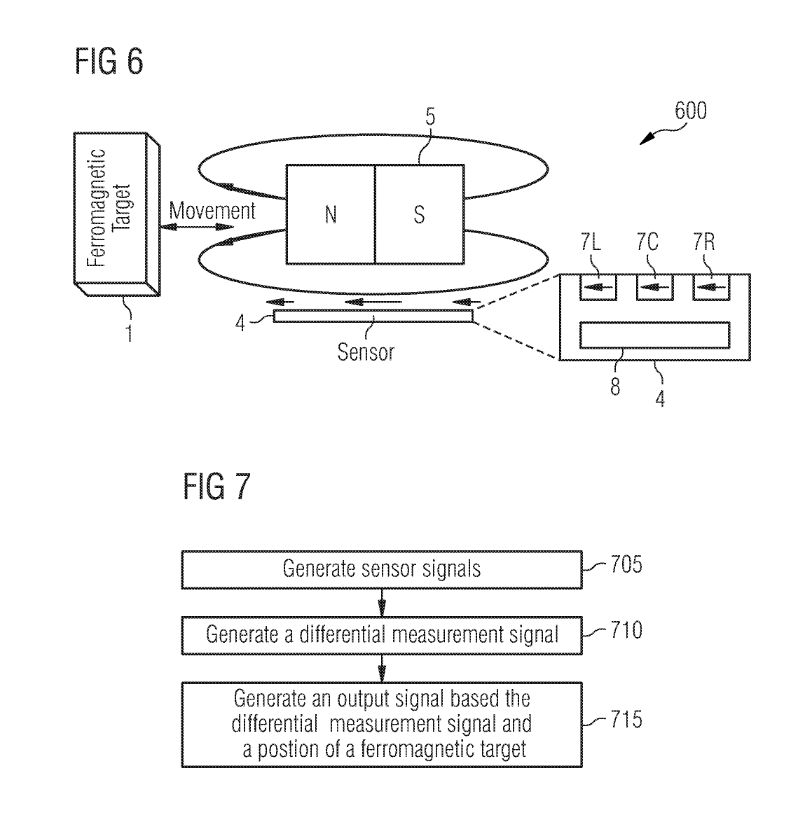

FIG. 6 shows a schematic diagram of a sensor system 600 according to one or more embodiments. It is to be noted that an enlarged cross sectional view of the sensor arrangement 4 is drawn to the right, connected by dashed expansion lines to the sensor element 4 drawn adjacent to the magnetic field lines.

In particular, similar to the sensor system 500 shown in FIG. 5, sensor system 600 includes sensor arrangement 4 and a back bias magnet 5. Additionally, the sensor system includes three magnetic field sensor elements 7L, 7C and 7R, spaced apart, having a same sensitivity axis (e.g., x-axis) aligned a same sensing direction (e.g., the −Bx direction). Thus, equation (2) may be used by the sensor circuit 8 to generate the differential measurement signal.

While the above examples include using two or three magnetic field sensor elements, it will be appreciated that more than three magnetic field sensor elements may be used as long as they are configured to sense the same magnetic field component for position sensing.

FIG. 7 shows a flow diagram of a magnetic field sensing method 700 according to one or more embodiment. In particular, the sensing method 700 includes generating sensor signals using two or more sensor elements (operation 705), generating a differential measurement signal using the sensor signals (operation 710), and generating an output signal based on the differential measurement signal and a position of a ferromagnetic target (operation 715).

In view of the above example embodiments, xMR sensor elements or the Hall sensor elements are sensitive to the same magnetic field components, for example, in-plane magnetic field components (parallel to a main surface of the sensor elements) or out-of-plane magnetic field components (perpendicular to the main surface of the sensor elements), and are used to generate a differential measurement signal that is substantially independent (i.e., within an acceptable tolerance) from homogeneous external stray fields, yet representative of a position of a ferromagnetic target with respect to the sensor elements. Additional signal processing and conditioning may be performed to generate an digital output signal. The digital output signal may indicate a position of the ferromagnetic target or it may indicate that the ferromagnetic target is within or outside a target proximity of the sensor elements (e.g., a preset distance from the sensor elements). The digital output signal may further be linearized with respect to a movement of the ferromagnetic target.

While the above embodiments are described in the context of detecting a wheel or camshaft speed, the sensor may be used to detect the rotation speed of any rotating member or object that creates sinusoidal variations in a magnetic field as it rotates and that may be sensed by a sensor. For example, a combination of a ferrous wheel and a back bias magnet may be used to generate a time varying magnetic field. Alternatively, an active encoder wheel (without a back bias magnetic) may be used to generate a time varying magnetic field.

Further, while various embodiments have been described, it will be apparent to those of ordinary skill in the art that many more embodiments and implementations are possible within the scope of the invention. Accordingly, the invention is not to be restricted except in light of the attached claims and their equivalents. With regard to the various functions performed by the components or structures described above (assemblies, devices, circuits, systems, etc.), the terms (including a reference to a “means”) used to describe such components are intended to correspond, unless otherwise indicated, to any component or structure that performs the specified function of the described component (i.e., that is functionally equivalent), even if not structurally equivalent to the disclosed structure that performs the function in the exemplary implementations of the invention illustrated herein.

Furthermore, the following claims are hereby incorporated into the detailed description, where each claim may stand on its own as a separate example embodiment. While each claim may stand on its own as a separate example embodiment, it is to be noted that—although a dependent claim may refer in the claims to a specific combination with one or more other claims—other example embodiments may also include a combination of the dependent claim with the subject matter of each other dependent or independent claim. Such combinations are proposed herein unless it is stated that a specific combination is not intended. Furthermore, it is intended to include also features of a claim to any other independent claim even if this claim is not directly made dependent to the independent claim.

It is further to be noted that methods disclosed in the specification or in the claims may be implemented by a device having means for performing each of the respective acts of these methods.

Further, it is to be understood that the disclosure of multiple acts or functions disclosed in the specification or claims may not be construed as to be within the specific order. Therefore, the disclosure of multiple acts or functions will not limit these to a particular order unless such acts or functions are not interchangeable for technical reasons. Furthermore, in some embodiments a single act may include or may be broken into multiple sub acts. Such sub acts may be included and part of the disclosure of this single act unless explicitly excluded.

1. A magnetic field position sensor, comprising:
at least two magnetic field sensor elements configured to generate sensor signals in response to a magnetic field, wherein the at least two magnetic field sensor elements are sensitive to a same magnetic field component of the magnetic field; and
a sensor circuit configured to generate a differential measurement signal based on the sensor signals, wherein the differential measurement signal oscillates linearly between two extrema, and to generate an output signal that is modulated based on a linear function of the differential measurement signal.

2. The magnetic field position sensor of claim 1, wherein the same magnetic field component is an in-plane magnetic field component.

3. The magnetic field position sensor of claim 1, wherein the at least two magnetic field sensor elements share a sensitivity axis.

4. The magnetic field position sensor of claim 1, wherein the at least two magnetic field sensor elements include a first magnetic field sensor element located at a first sensor position and a second magnetic field sensor element located at a second sensor position, wherein the differential measurement signal represents a difference between the magnetic field present at the first sensor position and the second sensor position.

5. The magnetic field position sensor of claim 1, wherein the at least two magnetic field sensor elements include a first magnetic field sensor element, a second magnetic field sensor element and a third magnetic field sensor element grouped into a first differential pair and a second differential pair, and
the sensor circuit is configured to generate a first difference between the sensor signals generated by the first differential pair, generate a second difference between the sensor signals generated by the second differential pair, and generate the differential measurement signal based on a difference between the first difference and the second difference.

6. The magnetic field position sensor of claim 1, wherein a characteristic of the magnetic field changes in response to a position of a target object, and the differential measurement signal is representative of the position of the target object with respect to the at least two magnetic field sensor elements.

7. The magnetic field position sensor of claim 6, wherein the sensor circuit is configured to generate the output signal based on a linear position of the target object relative to the magnetic field position sensor according to the differential measurement signal.

8. The magnetic field position sensor of claim 6, wherein the sensor circuit is further configured to generate the output signal based on a linear movement of the target object relative to the at least two magnetic field sensor elements,
wherein the sensor circuit is configured to monitor the differential measurement signal and change a logic state of the output signal in response to a trigger event.

9. The magnetic field position sensor of claim 8, wherein the trigger event is a crossing of a threshold by the differential measurement signal, the threshold corresponding to a predetermined distance of the target object from the at least two magnetic field sensor elements.

10. The magnetic field position sensor of claim 6, wherein the target object is configured to move laterally across the magnetic field position sensor in a linear path, and
wherein the at least two magnetic field sensor elements share a sensitivity axis, and the linear path is orthogonal or parallel to the sensitivity axis.

11. The magnetic field position sensor of claim 1, further comprising:
a back bias magnet configured to produce at least part of the magnetic field,
wherein the at least two magnetic field sensor elements and the sensor circuit are integrated on a semiconductor die, and
the semiconductor die and the back bias magnet are incorporated in a semiconductor package.

12. The magnetic field position sensor of claim 1, wherein:
the at least two magnetic field sensor elements includes a first magnetic field sensor element and a second magnetic field sensor element, and
the sensor circuit is configured to generate the differential measurement signal by canceling out a first external magnetic stray field component measured by the first magnetic field sensor element and a second external magnetic stray field component measured by the second magnetic field sensor element.

13. A magnetic field sensing method, comprising:
measuring a same magnetic field component of a magnetic field in at least two sensing locations;
generating sensor signals, including a sensor signal for each sensing location, based on measuring the same magnetic field component of the magnetic field in the at least two sensing locations;
generating a differential measurement signal based on the sensor signals, wherein the differential measurement signal oscillates linearly between two extrema; and
generating an output signal that is modulated based on a linear function of the differential measurement signal.

14. The magnetic field sensing method of claim 13, wherein the same magnetic field component is an in-plane magnetic field component.

15. The magnetic field sensing method of claim 13, wherein the at least two magnetic field sensor elements share a sensitivity axis.

16. The magnetic field sensing method of claim 13, wherein the differential measurement signal represents a difference between the magnetic field present at a first sensing location and the magnetic field present at a second sensing location.

17. The magnetic field sensing method of claim 13, further comprising:
grouping a first magnetic field sensor element, a second magnetic field sensor element, and a third magnetic field sensor element into a first differential pair and a second differential pair, wherein the first magnetic field sensor element, the second magnetic field sensor element, and the third magnetic field sensor element are located at a respective sensing location of the at least two sensing locations and generate the sensing signals, and
generating the differential measurement signal includes:
generating a first difference between the sensor signals generated by the first differential pair;
generating a second difference between the sensor signals generated by the second differential pair; and
generating the differential measurement signal based on a difference between the first difference and the second difference.

18. The magnetic field sensing method of claim 13, wherein a characteristic of the magnetic field changes in response to a position of a target object, and the differential measurement signal is representative of the position of the target object with respect to the at least two sensing locations.

19. The magnetic field sensing method of claim 18, further comprising:
generating the output signal based on a linear position of the target object relative to the at least two sensing locations according to the differential measurement signal.

20. The magnetic field sensing method of claim 18, further comprising:
generating the output signal based on a linear movement of the target object relative to the at least two sensing locations, including monitoring the differential measurement signal and changing a logic state of the output signal in response to a trigger event.

21. The magnetic field sensing method of claim 20, wherein the trigger event is a crossing of a threshold by the differential measurement signal, the threshold corresponding to a predetermined distance of the target object from the at least two sensing locations.

22. The magnetic field sensing method of claim 13, wherein:
generating the differential measurement signal includes canceling out a first external magnetic stray field component measured at a first sensing location and a second external magnetic stray field component measured at a second sensing location.
